(19) United States
(12) Patent Application Publication
(10) Pub. No.: US 2023/0184453 A1
(43) Pub. Date: Jun. 15, 2023

(54) AIR-CONDITIONING MONITORING DEVICE AND AIR-CONDITIONING SYSTEM

(71) Applicant: Mitsubishi Electric Corporation, Tokyo (JP)

(72) Inventor: Hiroaki OBANA, Tokyo (JP)

(21) Appl. No.: 17/998,453

(22) PCT Filed: Jul. 10, 2020
(86) PCT No.: PCT/JP2020/027022

§ 371 Date: Nov. 10, 2022

(51) Int. Cl. F24F 11/63; F24F 11/76

(52) U.S. Cl. CPC F24F 11/63; F24F 11/76; F24F 2110/12

(57) ABSTRACT

An air-conditioning monitoring device connected to and capable of communicating with an air-conditioning cooling energy device to collect air-conditioning data related to air-conditioning control from the air-conditioning cooling energy device, the air-conditioning monitoring device including: a storage unit configured to store therein the air-conditioning data collected from the air-conditioning cooling energy device; an inference processing unit configured to input an input value to a learning model and infer control parameters for the air-conditioning cooling energy device; and an input value selection unit configured to determine whether a first candidate value derived from the air-conditioning data has reliability when the first candidate value is used as the input value, and select the input value according to a result of the determination, the air-conditioning data being current air-conditioning data of the air-conditioning cooling energy device.

### CROSS REFERENCE TO RELATED APPLICATION

This application is a U.S. national stage application of International Patent Application No. PCT/JP2020/027022 filed on Jul. 10, 2020, the disclosure of which is incorporated herein by reference.

### TECHNICAL FIELD

The present disclosure relates to an air-conditioning monitoring device that manages an air-conditioning cooling energy device, and also relates to an air-conditioning system including the air-conditioning monitoring device.

### BACKGROUND

In general, an air-conditioning monitoring device collects air-conditioning data from an air-conditioning cooling energy device including a compressor and a heat exchanger, and manages the air-conditioning cooling energy device based on the collected air-conditioning data, such that the air-conditioning cooling energy device can provide a comfortable environment for users while reducing power consumption during its operation. Examples of the air-conditioning data collected from the air-conditioning cooling energy device include environmental data such as a room temperature, and control parameters for the air-conditioning cooling energy device. Some of the air-conditioning monitoring devices as described above are configured to determine control parameters for the air-conditioning cooling energy device such that the room temperature reaches a target temperature at a target time (see, for example, Patent Literature 1). Patent Literature 1 discloses a technique in which the artificial intelligence determines control parameters, including the time at which precooling starts and the time at which pre-warming starts, by using the air-conditioning data having been stored in the past and the current air-conditioning data.

### PATENT LITERATURE

Patent Literature 1: Japanese Unexamined Patent Application Publication No. 2017-067427

As described above, Patent Literature 1 discloses the technique configured to determine such control parameters that allow the room temperature to reach the target temperature at the target time by using the past air-conditioning data of the air-conditioning cooling energy device (hereinafter, referred to as “learning data”) and the current air-conditioning data of the air-conditioning cooling energy device. However, the installation environment, type of device, how it is used, and other conditions differ between the air-conditioning cooling energy devices depending on the building in which they are installed. It is thus difficult to prepare in advance the learning data suitable for the building in which the air-conditioning cooling energy device is installed, before shipment. In some cases, the volume of learning data may be insufficient for the air-conditioning monitoring device, or the learning data may have a biased tendency. Therefore, at the initial phase at which the air-conditioning cooling energy device has just become operational after shipment, a learning model is built by using such inadequate learning data as described above, and control parameters are inferred by this learning model. This causes a gap between the estimated operation and the actual operation. Consequently, air-conditioning desired by the users cannot be achieved.

### SUMMARY

The present disclosure has been made to solve the above problems, and an object of the present disclosure is to provide an air-conditioning monitoring device and an air-conditioning system that can condition air as desired by users.

An air-conditioning monitoring device according to one embodiment of the present disclosure is an air-conditioning monitoring device connected to and capable of communicating with an air-conditioning cooling energy device to collect air-conditioning data related to air-conditioning control from the air-conditioning cooling energy device, the air-conditioning monitoring device including: a storage unit configured to store therein the air-conditioning data collected from the air-conditioning cooling energy device; an inference processing unit configured to input an input value to a learning model and infer control parameters for the air-conditioning cooling energy device; and an input value selection unit configured to determine whether a first candidate value derived from the air-conditioning data has reliability when the first candidate value is used as the input value, and select the input value according to a result of the determination, the air-conditioning data being current air-conditioning data of the air-conditioning cooling energy device.

An air-conditioning system according to another embodiment of the present disclosure includes: the air-conditioning monitoring device described above; and an air-conditioning cooling energy device connected to and capable of communicating with the air-conditioning monitoring device, the air-conditioning cooling energy device being configured to condition air in an air-conditioned space.

In the air-conditioning monitoring device and the air-conditioning system according to the embodiments of the present disclosure, whether the first candidate value derived from the current air-conditioning data has reliability when this first candidate value is used as an input value is determined, and control parameters are inferred by using the input value selected according to the result of the determination. Therefore, the air-conditioning monitoring device and the air-conditioning system can prevent use of an imperfect learning model for determining control parameters, and can thus condition the air as desired by users.

### BRIEF DESCRIPTION OF DRAWINGS

FIG. 1 illustrates an example of a configuration of an air-conditioning system according to Embodiment 1.

FIG. 2 is a circuit diagram illustrating an example of a configuration of an air-conditioning apparatus illustrated in FIG. 1.

FIG. 3 is a functional block diagram illustrating an example of a configuration of an air-conditioning monitoring device illustrated in FIG. 1.

FIG. 4 is a flowchart illustrating control that is executed by an input value selection unit illustrated in FIG. 3.

FIG. 5 is a graph showing an input value and learning data in a three-dimensional Euclidean space when the input value is determined to have reliability.

FIG. 6 is a graph showing the input value and the learning data illustrated in FIG. 5 in the xy coordinates.

FIG. 7 is a graph showing the input value and the learning data illustrated in FIG. 5 in the xz coordinates.

FIG. 8 is a graph showing the input value and the learning data illustrated in FIG. 5 in the yz coordinates.

FIG. 9 is a graph showing the input value and the learning data in the three-dimensional Euclidean space when the input value is determined not to have reliability.

FIG. 10 is a graph showing the input value and the learning data illustrated in FIG. 9 in the xz coordinates.

FIG. 11 is a graph showing the input value and the learning data illustrated in FIG. 9 in the xy coordinates.

FIG. 12 is a graph showing the input value and the learning data illustrated in FIG. 9 in the yz coordinates.

### DETAILED DESCRIPTION

### Embodiment 1

### (Configuration of Air-Conditioning System)

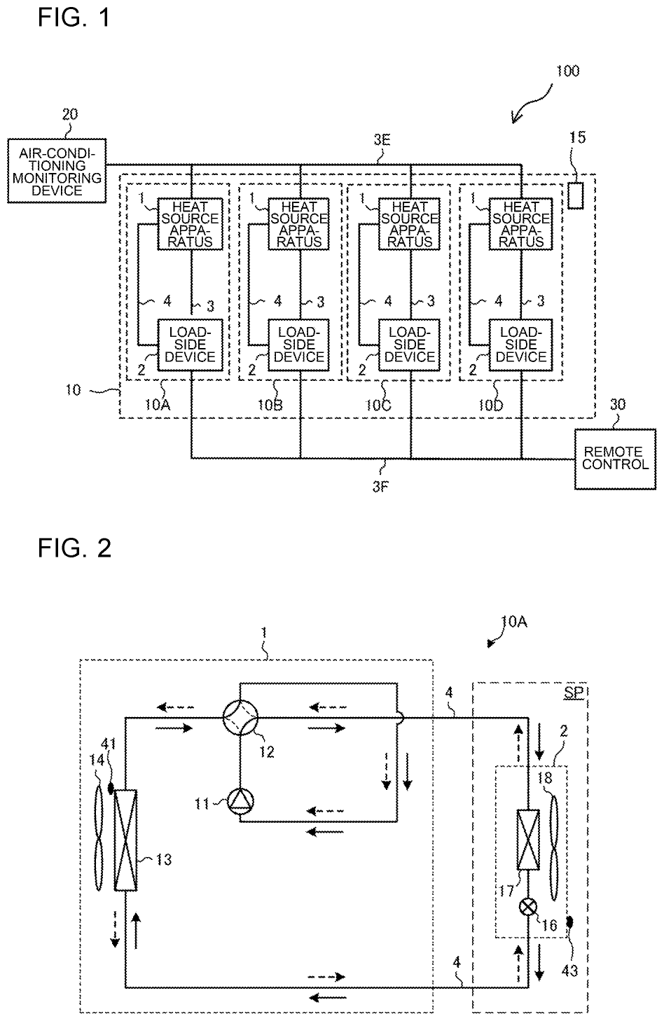

FIG. 1 illustrates an example of a configuration of an air-conditioning system according to Embodiment 1. As illustrated in FIG. 1, an air-conditioning system 100 includes an air-conditioning cooling energy device 10, an air-conditioning monitoring device 20 configured to manage the air-conditioning cooling energy device 10, and a remote control 30 that is manipulated by a user to input a command to the air-conditioning cooling energy device 10.

### (Configuration of Air-Conditioning Cooling Energy Device 10)

The air-conditioning cooling energy device 10 conditions the air in a room space SP that is an air-conditioned space, and includes a plurality of air-conditioning apparatuses 10A to 10D, a controller 15, and a plurality of sensors. Each of the plurality of air-conditioning apparatuses 10A to 10D includes a heat source apparatus 1 and a load-side device 2. The heat source apparatus 1 and the load-side device 2 are connected through a refrigerant pipe 4. The heat source apparatus 1 and the load-side device 2 are also connected through an internal signal line 3. A plurality of load-side devices 2 are installed in the room space SP (see FIG. 2 described later).

FIG. 2 is a circuit diagram illustrating an example of a configuration of the air-conditioning apparatus illustrated in FIG. 1. The solid arrows in FIG. 2 show the direction in which refrigerant flows during heating operation. The dotted arrows in FIG. 2 show the direction in which refrigerant flows during cooling operation. As illustrated in FIG. 2, the heat source apparatus 1 of the air-conditioning apparatus 10A includes a compressor 11, a flow switching valve 12 configured to switch between the flow passages of refrigerant, an outdoor heat exchanger 13, and an outdoor fan 14 configured to deliver air to the outdoor heat exchanger 13. The flow switching valve 12 is, for example, a four-way valve, and changes the refrigerant flow direction by switching between the connection state for cooling operation and the connection state for heating operation. The outdoor heat exchanger 13 serves as a condenser during the cooling operation and serves as an evaporator during the heating operation.

The load-side device 2 of the air-conditioning apparatus 10A includes a pressure reducing valve 16, an indoor heat exchanger 17, and an indoor fan 18 configured to deliver air to the indoor heat exchanger 17. The indoor heat exchanger 17 serves as an evaporator during cooling operation, and serves as a condenser during heating operation. The air-conditioning apparatuses 10B to 10D have the same configuration as that of the air-conditioning apparatus 10A, and therefore the descriptions of the air-conditioning apparatuses 10B to 10D are omitted.

The air-conditioning cooling energy device 10 includes an outside air temperature sensor 41 configured to measure the outside air temperature that is a temperature of the outside air with which the outdoor heat exchanger 13 exchanges heat. The air-conditioning cooling energy device 10 includes a room temperature sensor 43 configured to measure the temperature of the room air.

The controller 15 is installed in, for example, the heat source apparatus 1 described above. The controller 15 includes a timer configured to measure the time, a memory (not illustrated), and a microcomputer (not illustrated) configured to execute processes according to a program. The memory (not illustrated) is, for example, a nonvolatile memory.

The controller 15 illustrated in FIG. 1 is connected to the compressor 11 illustrated in FIG. 2, a motor (not illustrated) of the outdoor fan 14, the outside air temperature sensor 41, the pressure reducing valve 16 of the load-side device 2, a motor (not illustrated) of the indoor fan 18, and the room temperature sensor 43 through signal lines. The controller 15 is also connected to the remote control 30 through a signal line 3F illustrated in FIG. 1, and receives a command from the remote control 30. Settings are made to the controller 15 through the remote control 30. Examples of the settings include start and stop of the cooling operation, start and stop of the heating operation, selection of the operation, a temperature setting, and an airflow amount setting.

When receiving an input of an operational command from a user through the remote control 30, the controller 15 starts driving the compressor 11, the outdoor fan 14, and the indoor fan 18 that are illustrated in FIG. 2. The controller 15 controls the opening degree of the pressure reducing valve 16, the operational frequency of the compressor 11, the rotation speed of the outdoor fan 14, and the rotation speed of the indoor fan 18, such that the value measured by the room temperature sensor 43 reaches the temperature instructed by the user.

The controller 15 is connected to the air-conditioning monitoring device 20 through a signal line 3E. The controller 15 transmits air-conditioning data to the air-conditioning monitoring device 20 in response to a request from the air-conditioning monitoring device 20. The controller 15 is configured to receive a command from the air-conditioning monitoring device 20, control each of the heat source apparatuses 1 and each of the load-side devices 2 according to the received command, and precool or pre-warm the room space SP that is an air-conditioned space.

### (Configuration of Air-Conditioning Monitoring Device 20)

The air-conditioning monitoring device 20 is connected to the air-conditioning cooling energy device 10 through the signal line 3E, and collects data from the air-conditioning cooling energy device 10. Specifically, the air-conditioning monitoring device 20 is connected to the controller 15 of the air-conditioning cooling energy device 10 through the signal line 3E, and collects air-conditioning data related to the operational state of the heat source apparatuses 1 and the load-side devices 2 in the plurality of air-conditioning apparatuses 10A to 10D from the controller 15. The air-conditioning data relates to the air-conditioning control for the air-conditioning cooling energy device 10. The air-conditioning data is information indicating the operational state, and environmental information such as values detected by various sensors. Specifically, the air-conditioning data includes information such as the room temperature measured by the room temperature sensor 43, the set temperature, the outside air temperature measured by the outside air temperature sensor 41, and the number of load-side devices 2 that are currently in operation simultaneously.

The air-conditioning monitoring device 20 transmits a request to the air-conditioning cooling energy device 10 and collects data from the air-conditioning cooling energy device 10 at a given time interval, for example, on the same date and at the same time every month. Note that the data collection is not limited to being performed monthly, but may be performed weekly or every 10 days, or at other intervals. The air-conditioning monitoring device 20 is configured to collect the air-conditioning data from the air-conditioning cooling energy device 10 at a predetermined timing such as at the start-up of the air-conditioning cooling energy device 10. The air-conditioning monitoring device 20 is also configured to cause the air-conditioning cooling energy device 10 to precool or pre-warm the room space SP, such that the room temperature reaches the target temperature at the target time (for example, at the time when users start using the room space SP) in the room space SP.

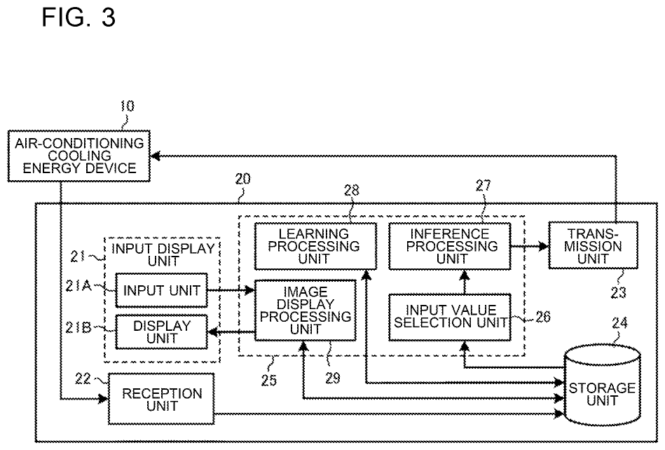

FIG. 3 is a functional block diagram illustrating an example of a configuration of the air-conditioning monitoring device illustrated in FIG. 1. As illustrated in FIG. 3, the air-conditioning monitoring device 20 includes an input display unit 21, a reception unit 22, a transmission unit 23, a storage unit 24, and a control unit 25 configured to control each unit.

The control unit 25 is made up of either dedicated hardware or a central processing unit (CPU) configured to execute programs stored in a memory. Note that the CPU is also referred to as a “central processing device,” a “processing device,” a “computation device,” a “microprocessor,” a “microcomputer,” or a “processor.”

When the control unit 25 is dedicated hardware, the control unit 25 is equivalent to, for example, a single circuit, a combined circuit, an application specific integrated circuit (ASIC), a field-programmable gate array (FPGA), or a combination thereof. The functional units of the control unit 25 may be individually implemented by separate units of hardware, or the functional units of the control unit 25 may be implemented together by a single unit of hardware.

When the control unit 25 is the CPU, the functions that are executed by the control unit 25 are implemented by software, firmware, or a combination of the software and the firmware. The software and the firmware are described as programs and stored in the memory. The CPU reads and executes the programs stored in the memory, thereby implementing the functions of the control unit 25. For example, the memory is a nonvolatile or volatile semiconductor memory such as a RAM, a ROM, a flash memory, an EPROM, or an EEPROM.

The functions of the control unit 25 may be partially implemented by dedicated hardware, while being partially implemented by software or firmware.

The input display unit 21 includes an input unit 21A on which the settings information for the air-conditioning cooling energy device 10 is manipulated, and a display unit 21B configured to display the operating information about the air-conditioning cooling energy device 10. The input unit 21A is made up of, for example, a keyboard, through which the input information is transmitted to the control unit 25. The display unit 21B is made up of a display, and displays information received from the control unit 25. Note that the input display unit 21 may be made up of a touch panel or the like in which the input unit 21A and the display unit 21B are integrated into one.

The reception unit 22 is a functional unit configured to receive data from the outside. Specifically, the reception unit 22 receives air-conditioning data of the air-conditioning cooling energy device 10, and stores the received air-conditioning data in the storage unit 24. The storage unit 24 has stored therein learning data that will be described later, information related to the scheduled use of the room space SP, thresholds, and other information. Examples of the information related to the scheduled use include the date and time of use of the room space SP and the set temperature. The transmission unit 23 is a functional unit configured to transmit data to the outside. Specifically, the transmission unit 23 transmits command data including control parameters for the air-conditioning cooling energy device 10 determined by the control unit 25 to the air-conditioning cooling energy device 10. For example, the control parameters include, when the air-conditioning cooling energy device 10 is operated according to the scheduled use, the time at which precooling or pre-warming starts, and the control values for each device of the air-conditioning cooling energy device 10 during the precooling or pre-warming.

The control unit 25 is a functional unit configured to perform computation using the information stored in the storage unit 24 in response to the manipulation on the input unit 21A, and transmit the computed result to the display unit 21B or the transmission unit 23. The control unit 25 includes an image display processing unit 29, an inference processing unit 27, an input value selection unit 26, and a learning processing unit 28. The image display processing unit 29 is configured to display information on the display unit 21B based on the information input to the input unit 21A and the information stored in the storage unit 24. The inference processing unit 27 infers control parameters for the air-conditioning cooling energy device 10 by using a learning model stored in the storage unit 24. The input value selection unit 26 is configured to select an input value that is input to the learning model in the inference processing unit 27. The learning processing unit 28 is configured to build a learning model by using the learning data stored in the storage unit 24. The learning model is used in the inference processing unit 27. The learning model built by the learning processing unit 28 is stored in the storage unit 24.

As one of the methods for building a learning model, for example, according to a neural network model, a learning model is built by supervised learning. In this method, learning data containing a large volume of data is read into a neural network to build the neural network with optimized synaptic “weights” as a learning model. The learning model is expressed by a specific calculation expression after learning. In the learning processing unit 28, the values of weights are adjusted such that the output result relative to the air-conditioning data is the operation set by the user.

Inference is a process of producing an output from the input value by using a learning model. The inference processing unit 27 inputs the values derived from the obtained air-conditioning data to the learning model built in the learning processing unit 28, and outputs control parameters for the air-conditioning cooling energy device 10. That is, the inference processing unit 27 infers the control parameters by calculating them using a calculation expression determined by the learning model relative to the obtained air-conditioning data.

The function of the input value selection unit 26 is described below in more detail. The input value selection unit 26 derives a first candidate value from the current air-conditioning data of the air-conditioning cooling energy device 10, determines whether the first candidate value has reliability when it is used as an input value for inference, and selects the input value to be used in the inference processing unit 27 according to the result of the determination. The first candidate value includes elements that are, for example, the difference between the room temperature and the set temperature, the difference between the outside air temperature and the room temperature, and the number of load-side devices 2 in operation simultaneously. Reliability is an attribute that allows a target object to serve the required function under the given conditions for a specified period of time. When an input value having reliability is used for inference, it is conceivable that the inferred operation is almost identical with the actual operation, and thus the expected operation is performed. In contrast, when an input value not having reliability is used for inference, it is conceivable that this causes a gap between the inferred operation and the actual operation, and thus the expected operation is not performed.

The learning data stored in the storage unit 24 includes a plurality of second candidate values. As the plurality of second candidate values, the learning data includes prepared data stored in the storage unit 24 in advance before shipment, and values derived from the past air-conditioning data. Similarly to the first candidate value, the second candidate value includes elements that are the difference between the room temperature and the set temperature, the difference between the outside air temperature and the room temperature, and the number of load-side devices 2 in operation simultaneously. Note that the prepared data can be omitted, and the plurality of second candidate values can be made up of only the values derived from the past air-conditioning data.

When determining that the first candidate value has reliability, the input value selection unit 26 selects the first candidate value as an input value. When determining that the first candidate value does not have reliability, the input value selection unit 26 selects, from among the plurality of second candidate values included in the learning data, the second candidate value closest to the first candidate value as the input value. Specifically, when determining that the first candidate value does not have reliability, the input value selection unit 26 selects, from among the plurality of second candidate values included in the learning data, the second candidate value with the shortest Euclidean distance from the first candidate value as the input value. In a case where the first candidate value and the second candidate value are both made up of three elements, the Euclidean distance between the first candidate value and the second candidate value is the distance between two points in the three-dimensional Euclidean space.

In the input value selection unit 26, whether the input value has reliability is determined based on the first candidate value derived from the current air-conditioning data, and based on the plurality of second candidate values included in the learning data stored in the storage unit 24. Specifically, the input value selection unit 26 determines that the first candidate value has reliability when the elements making up the first candidate value all satisfy a predetermined condition. The input value selection unit 26 determines that the first candidate value has reliability when all of its elements satisfy the condition that, for example, the first candidate value falls within the range between two second candidate values defined as an upper-limit value and a lower-limit value whose difference is equal to or smaller than a threshold.

The threshold is predetermined for each element of the input value and stored in the storage unit 24. The threshold is determined by experiment or the like. For example, before the air-conditioning system 100 becomes operational, a distribution of each of the elements described above is derived from a plurality of pieces of air-conditioning data collected from the air-conditioning cooling energy device 10, and then the threshold can be determined based on the differences in the element in the similar operation states in the distribution.

### (Description of Operation of Air-Conditioning System 100)

As illustrated in FIG. 3, the air-conditioning monitoring device 20 receives the current air-conditioning data of the air-conditioning cooling energy device 10 from the reception unit 22, and stores the received current air-conditioning data in the storage unit 24. Next, the learning processing unit 28 uses the learning data stored in the storage unit 24 to build a learning model. Subsequently, the input value selection unit 26 determines reliability by using the current air-conditioning data and the learning data stored in the storage unit 24. When determining that the first candidate value derived from the current air-conditioning data has reliability, the input value selection unit 26 selects this first candidate value as the input value. When determining that the first candidate value derived from the current air-conditioning data does not have reliability, the input value selection unit 26 selects, from among the plurality of second candidate values included in the learning data, the second candidate value closest to the first candidate value as the input value. Next, the inference processing unit 27 infers control parameters by inputting the input value selected by the input value selection unit 26 to the learning model stored in the storage unit 24. Eventually, the transmission unit 23 transmits the control parameters inferred by the inference processing unit 27 to the air-conditioning cooling energy device 10.

### (Description of Operation of Input Value Selection Unit 26)

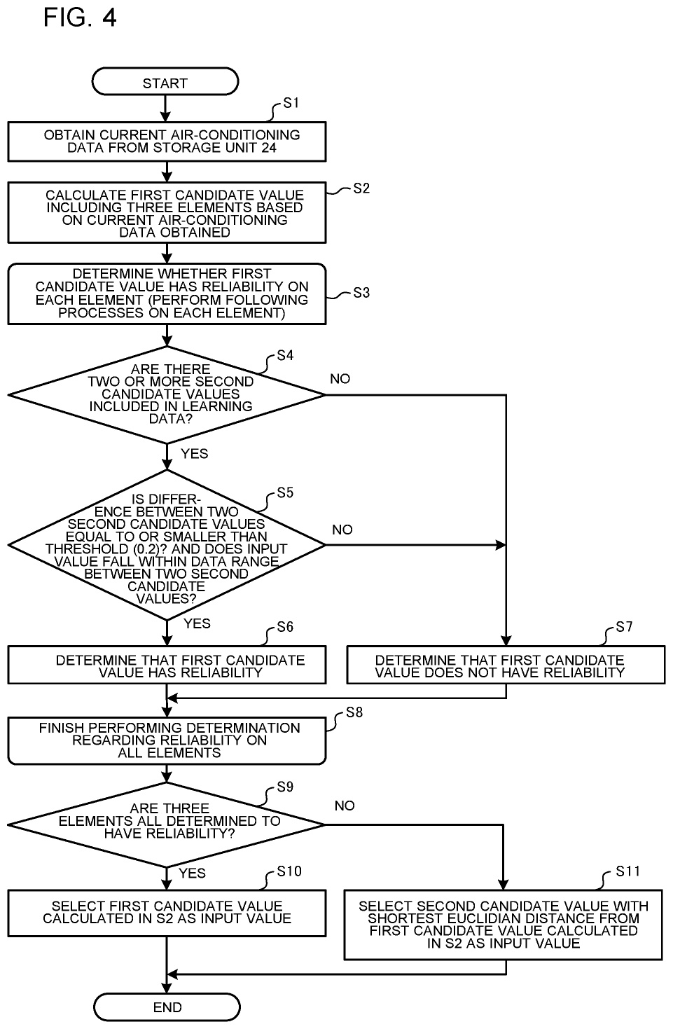

FIG. 4 is a flowchart illustrating the control that is executed by the input value selection unit illustrated in FIG. 3. As illustrated in FIG. 4, the input value selection unit 26 obtains the current air-conditioning data from the storage unit 24 (step S1). Specifically, the obtained air-conditioning data includes the room temperature, the set temperature, the outside air temperature, and the number of load-side devices 2 in operation simultaneously. The input value selection unit 26 calculates a first candidate value including three elements from the obtained air-conditioning data (step S2). Specifically, the first candidate value is calculated, including the difference between the room temperature and the set temperature, the difference between the outside air temperature and the room temperature, and the number of load-side devices 2 in operation simultaneously.

The input value selection unit 26 performs the determination process in steps S4 to S7 on each of the elements of the first candidate value, and determines whether the element has reliability (steps S3 to S7). In the determination process, first, whether the learning data includes two or more second candidate values is determined (step S4). When the learning data includes two or more second candidate values (step S4: YES), the input value selection unit 26 performs the determination in step S5. In step S5, a determination is made regarding whether the first candidate value falls within the range between two second candidate values defined as an upper-limit value and a lower-limit value and having a difference between the two candidate values equal to or smaller than a threshold (for example, 0.2) (step S5). When the condition in step S5 is satisfied (step S5: YES), the first candidate value is determined to have reliability (step S6). That is, the first candidate value is determined to be an input value that leads to inference of control parameters that result in a sufficiently small gap from the actual operation.

When the learning data does not include two or more second candidate values in step S4 (step S4: NO), or when the condition in step S5 is not satisfied (step S5: NO), the first candidate value is determined not to have reliability (step S7). That is, the first candidate value is determined to be an input value that leads to inference of control parameters that result in a large gap from the actual operation.

When the input value selection unit 26 finishes performing the determination regarding reliability on all of the elements of the first candidate value (step S8), the input value selection unit 26 determines whether the three elements are all determined to have reliability (step S9). When the condition in step S9 is satisfied (step S9: YES), the first candidate value calculated in step S2 is selected as an input value to be used for the inference process (step S10). In contrast, when the condition in step S9 is not satisfied (step S9: NO), the first candidate value calculated in step S2 is not used for the inference process, and instead, the second candidate value with the shortest Euclidean distance from the first candidate value is selected as an input value (step S11).

### (Numerical Example of Input Value)

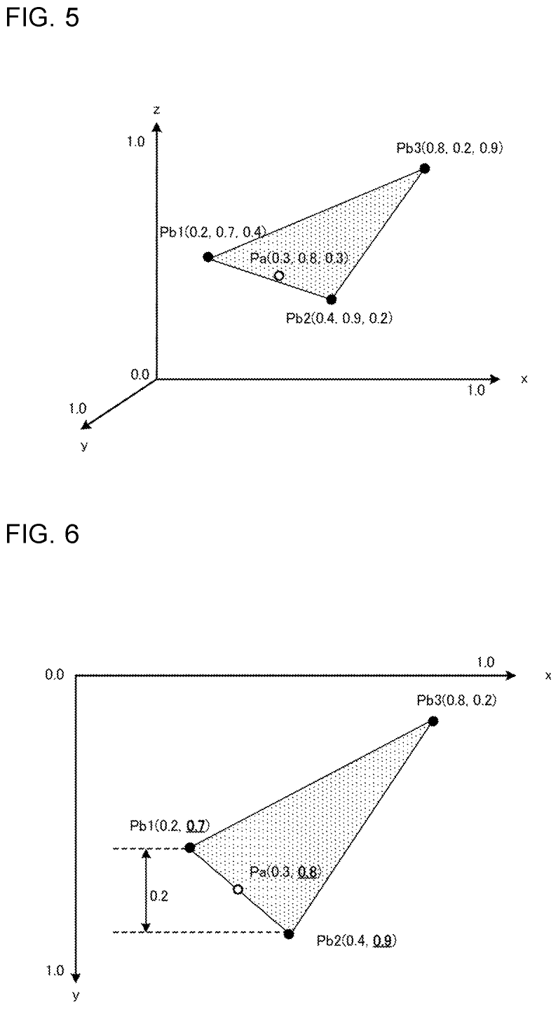

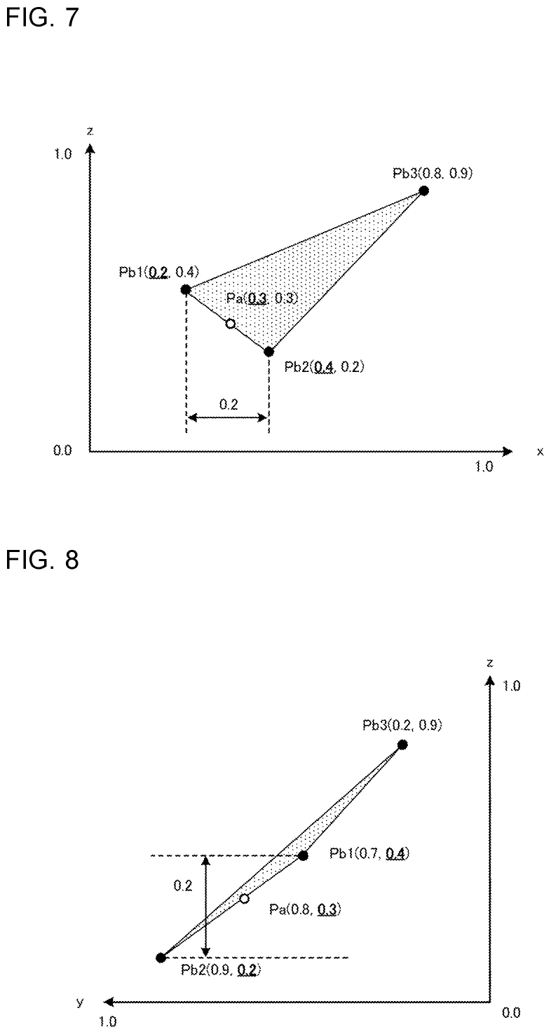

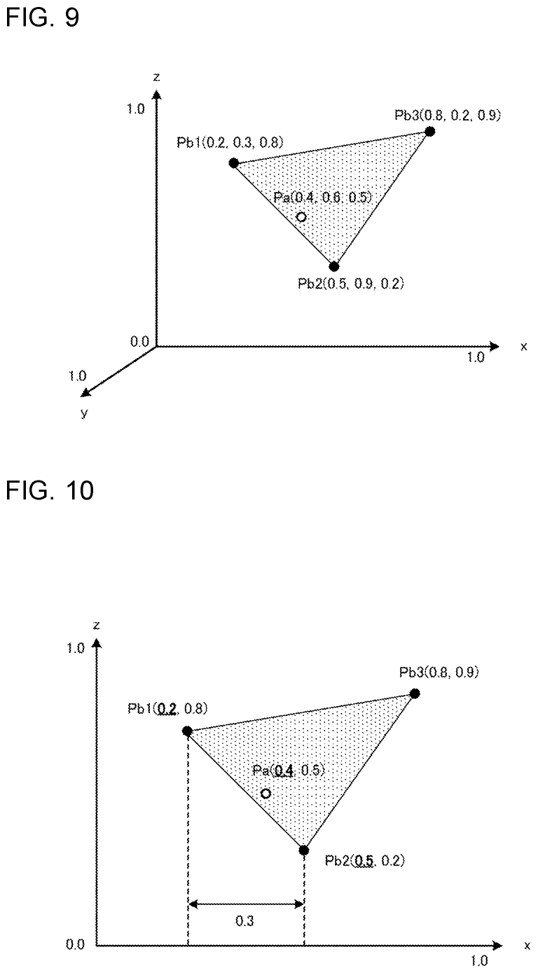

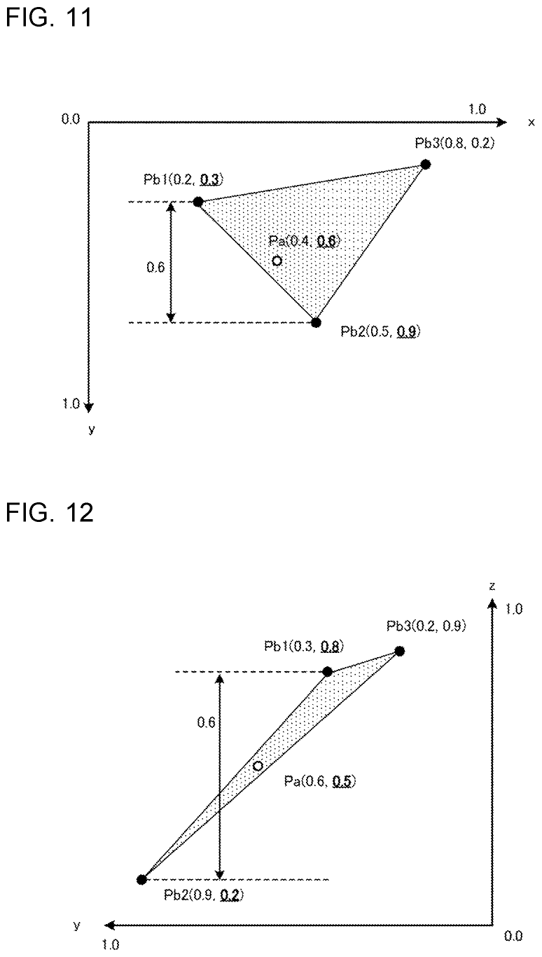

FIG. 5 is a graph showing the input value and the learning data in the three-dimensional Euclidean space when the input value is determined to have reliability. FIG. 6 is a graph showing the input value and the learning data illustrated in FIG. 5 in the xy coordinates. FIG. 7 is a graph showing the input value and the learning data illustrated in FIG. 5 in the xz coordinates. FIG. 8 is a graph showing the input value and the learning data illustrated in FIG. 5 in the yz coordinates. FIG. 9 is a graph showing the input value and the learning data in the three-dimensional Euclidean space when the input value is determined not to have reliability. FIG. 10 is a graph showing the input value and the learning data illustrated in FIG. 9 in the xz coordinates. FIG. 11 is a graph showing the input value and the learning data illustrated in FIG. 9 in the xy coordinates. FIG. 12 is a graph showing the input value and the learning data illustrated in FIG. 9 in the yz coordinates.

The steps in FIG. 4 described above are explained below with reference to FIGS. 5 to 12. In the graphs, the white circle represents a first candidate value Pa calculated in step S2, while the black circles represent second candidate values Pb1, Pb2, and Pb3 included in the learning data used for the determination in step S5. In FIGS. 5 and 9, the first candidate value Pa and the second candidate values Pb1, Pb2, and Pb3 are shown in the three-dimensional Euclidean space, in which the difference between the room temperature and the set temperature is defined as an x-element, the difference between the outside air temperature and the room temperature is defined as a y-element, and the number of load-side devices 2 in operation simultaneously is defined as a z-element. Note that for the sake of easy explanation, the difference between the room temperature and the set temperature defined as the x-element, the difference between the outside air temperature and the room temperature defined as the y-element, and the number of load-side devices 2 in operation simultaneously defined as the z-element are individually represented by a standardized numerical value.

FIGS. 6 to 8 and FIGS. 10 to 12 show the determination in step S5 that is performed on each of the elements. In the examples illustrated in FIGS. 5 to 8, the coordinates of the first candidate value Pa are (0.3, 0.8, 0.3), and the learning data includes three second candidate values Pb1 (0.2, 0.7, 0.4), Pb2 (0.4, 0.9, 0.2), and Pb3 (0.8, 0.2, 0.9). As illustrated in FIG. 6, for the y-element, the distance between the two adjacent second candidate values Pb1 and Pb2 among the second candidate values Pb1 to Pb3 included in the learning data is equal to or less than the threshold (0.2). The first candidate value (y=0.8) falls within the range between the second candidate values Pb1 (y=0.7) and Pb2 (y=0.9) that are defined respectively as a lower-limit value and an upper-limit value. As illustrated in FIG. 7, for the x-element, the distance between the two second candidate values Pb1 and Pb2 is equal to or less than the threshold (0.2). The first candidate value (x=0.3) falls within the range between the second candidate values Pb1 (x=0.2) and Pb2 (x=0.4) that are defined respectively as a lower-limit value and an upper-limit value. As illustrated in FIG. 8, for the z-element, the distance between the two second candidate values Pb1 and Pb2 is equal to or less than the threshold (0.2). The first candidate value (z=0.3) falls within the range between the second candidate values Pb1 (z=0.4) and Pb2 (z=0.2) that are defined respectively as an upper-limit value and a lower-limit value. Therefore, the first candidate value Pa shown in FIGS. 5 to 8 is determined to have reliability in relation to the learning data in step S9, and is thus selected as an input value (step S10 in FIG. 4).

In the examples illustrated in FIGS. 9 to 12, the coordinates of the first candidate value Pa are (0.4, 0.6, 0.5), and the learning data includes three second candidate values Pb1 (0.2, 0.3, 0.8), Pb2 (0.5, 0.9, 0.2), and Pb3 (0.8, 0.2, 0.9). As illustrated in FIG. 10, for the x-element, the distance between the two adjacent second candidate values Pb1 (x=0.2) and Pb2 (x=0.5) is 0.3 that is greater than the threshold (0.2). As illustrated in FIGS. 11 and 12, respectively for the y-element and the z-element, the distance between the second candidate values Pb1 and Pb2 is 0.6 that is greater than the threshold (0.2). Therefore, the first candidate value Pa shown in FIGS. 9 to 12 is determined not to have reliability in relation to the learning data in step S9, and is thus not selected as an input value. In this case, in step S11, the second candidate value Pb2 that is closest to the first candidate value Pa is selected as an input value.

As described above, in Embodiment 1, the air-conditioning monitoring device 20 is connected to and capable of communicating with the air-conditioning cooling energy device 10, and is configured to collect the air-conditioning data from the air-conditioning cooling energy device 10 and manage the air-conditioning cooling energy device 10. The air-conditioning monitoring device 20 includes the storage unit 24 configured to store therein the air-conditioning data collected from the air-conditioning cooling energy device 10, and the inference processing unit 27 configured to input an input value to a learning model and infer control parameters for the air-conditioning cooling energy device 10. The air-conditioning monitoring device 20 further includes the input value selection unit 26 configured to determine whether the first candidate value derived from the current air-conditioning data of the air-conditioning cooling energy device 10 has reliability when this first candidate value is used as an input value, and select the input value according to the result of the determination.

Due to this configuration, control parameters are inferred by using the input value selected based on the determination of whether the first candidate value has reliability. This can prevent use of an imperfect learning model for determining control parameters, and consequently allows the air-conditioning cooling energy device 10 to condition the air as desired by users.

The learning data used for building the learning model is stored in the storage unit 24. The input value selection unit 26 determines whether the first candidate value has reliability based on the first candidate value derived from the current air-conditioning data, and based on the plurality of second candidate values included in the learning data. Due to this configuration, the air-conditioning monitoring device 20 can determine whether the first candidate value has reliability for the learning model generated or updated by the learning data, and select the input value according to the result of the determination.

The learning data has values derived from the past air-conditioning data as the plurality of second candidate values. Due to this configuration, the learning model is affected by the past operational information obtained in the environment where the air-conditioning cooling energy device 10 is installed. Thus, the inference processing unit 27 can infer control parameters that are suitable for operation in the environment where the air-conditioning cooling energy device 10 is installed.

When determining that the first candidate value has reliability, the input value selection unit 26 selects this first candidate value as the input value. When determining that the first candidate value does not have reliability, the input value selection unit 26 selects, from among the plurality of second candidate values included in the learning data, the second candidate value with the shortest Euclidean distance from the first candidate value as the input value. Due to this configuration, in the air-conditioning cooling energy device 10, the input value, which has been used in the past operation for inference, is selected. This can prevent inference of control parameters that deviate significantly from the past control parameters.

The number of elements making up the first candidate value is equal to that of elements making up the second candidate value. The input value selection unit 26 determines that the first candidate value has reliability when each element making up the first candidate value and making up the second candidate value satisfies a predetermined condition. The condition is that the first candidate value (Pa) falls within the range between two of the plurality of second candidate values (Pb1 to Pb3), the two second candidate values (Pb1 and Pb2) being defined as an upper-limit value and a lower-limit value whose difference is equal to or smaller than a threshold (for example, 0.2). Due to this condition, in the air-conditioning cooling energy device 10, the input value, which is close to the first candidate value and has been used in the past operation for inference, is selected from among the second candidate values included in the learning data. This can prevent inference of control parameters that deviate significantly from the past control parameters.

Note that the embodiment of the present disclosure is not limited to the embodiment described above, but various changes may be made. For example, the air-conditioning cooling energy device 10 has been described as including four air-conditioning apparatuses 10A to 10B. However, the number of air-conditioning apparatuses is not limited to a particular number. Further, the air-conditioning monitoring device 20 determines whether the first candidate value has reliability. However, the air-conditioning monitoring device 20 may have a configuration to compute the degree of reliability including a probability, and determine whether the degree of reliability of each element is equal to or greater than a threshold, thereby to determine whether the degree of reliability is high or low. Further, the case where the first candidate value and the second candidate value are both made up of three elements has been described. However, the configuration is not particularly limited to this case. When the first candidate value is determined not to have reliability, the second candidate value with the shortest distance from the first candidate value in the Euclidean space with the number of dimensions equal to the number of elements of the first candidate value can be selected as an input value. A value of the air-conditioning data collected by the air-conditioning monitoring device 20 is not limited to being a single measurement value measured at a predetermined date and time in the air-conditioning cooling energy device 10. An average value of a plurality of measurement values measured for a given time period from a predetermined date and time may also be applicable.

1. An air-conditioning monitoring device connected to and capable of communicating with an air-conditioning cooling energy device to collect air-conditioning data related to air-conditioning control from the air-conditioning cooling energy device, the air-conditioning monitoring device comprising:
a storage unit configured to store therein the air-conditioning data collected from the air-conditioning cooling energy device; and
processing circuitry configured to input an input value to a learning model and infer control parameters for the air-conditioning cooling energy device, and
configured to determine whether a first candidate value derived from the air-conditioning data has reliability when the first candidate value is used as the input value, and select the input value according to a result of the determination, the air-conditioning data being current air-conditioning data of the air-conditioning cooling energy device.

2. The air-conditioning monitoring device of claim 1, wherein
learning data used for building the learning model is stored in the storage unit, and
the processing circuitry determines whether the first candidate value has the reliability based on the first candidate value derived from the current air-conditioning data, and based on a plurality of second candidate values included in the learning data.

3. The air-conditioning monitoring device of claim 2, wherein the learning data has values derived from the air-conditioning data as a plurality of the second candidate values, the air-conditioning data being past air-conditioning data.

4. The air-conditioning monitoring device of claim 2, wherein
the processing circuitry selects the first candidate value as the input value when determining that the first candidate value has the reliability, and
selects, from among a plurality of the second candidate values included in the learning data, the second candidate value with a shortest Euclidean distance from the first candidate value as the input value when determining that the first candidate value does not have the reliability.

5. The air-conditioning monitoring device of claim 4, wherein
the number of elements making up the first candidate value is equal to that of elements making up the second candidate value, and
the processing circuitry determines that the first candidate value has the reliability when each element making up the first candidate value and making up the second candidate value satisfies a condition that the first candidate value falls within a range between two of a plurality of the second candidate values, the two second candidate values being defined as an upper-limit value and a lower-limit value whose difference is equal to or smaller than a threshold.

6. The air-conditioning monitoring device of claim 5, wherein the first candidate value and the second candidate value are both made up of at least one of three elements including a difference between a room temperature and a set temperature in an air-conditioned space, a difference between an outside air temperature and the room temperature, and the number of load-side devices in operation simultaneously in the air-conditioning cooling energy device.

7. An air-conditioning system comprising:
the air-conditioning monitoring device of claim 1; and
an air-conditioning cooling energy device connected to and capable of communicating with the air-conditioning monitoring device, the air-conditioning cooling energy device being configured to condition air in an air-conditioned space.

8. The air-conditioning monitoring device of claim 3, wherein
the processing circuitry selects the first candidate value as the input value when determining that the first candidate value has the reliability, and
selects, from among a plurality of the second candidate values included in the learning data, the second candidate value with a shortest Euclidean distance from the first candidate value as the input value when determining that the first candidate value does not have the reliability.

9. The air-conditioning monitoring device of claim 8, wherein
the number of elements making up the first candidate value is equal to that of elements making up the second candidate value, and
the processing circuitry determines that the first candidate value has the reliability when each element making up the first candidate value and making up the second candidate value satisfies a condition that the first candidate value falls within a range between two of a plurality of the second candidate values, the two second candidate values being defined as an upper-limit value and a lower-limit value whose difference is equal to or smaller than a threshold.

10. The air-conditioning monitoring device of claim 9, wherein the first candidate value and the second candidate value are both made up of at least one of three elements including a difference between a room temperature and a set temperature in an air-conditioned space, a difference between an outside air temperature and the room temperature, and number of load-side devices in operation simultaneously in the air-conditioning cooling energy device.
